(19) United States
(12) Patent Application Publication
(10) Pub. No.: US 2025/0322013 A1
(43) Pub. Date: Oct. 16, 2025

(54) SYSTEMS AND METHODS FOR ARTIFICIAL FLY RECOMMENDATION

(71) Applicant: Glory Outdoors LLC, Enterprise, OR (US)

(72) Inventor: Kevin Lyon, Enterprise, OR (US)

(21) Appl. No.: 19/097,743

(22) Filed: Apr. 1, 2025

Related U.S. Application Data
(60) Provisional application No. 63/632,477, filed on Apr. 10, 2024.

(51) Int. Cl. G06F 16/538; G06F 16/532; G06Q 30/0601

(52) U.S. Cl. CPC G06F 16/538; G06F 16/532; G06Q 30/0633

(57) ABSTRACT

Methods and systems are provided for automatically recommending an artificial fly for fly fishing based on an image of an insect, and a mobile application configured to execute the systems and methods. In one example, the method comprises acquiring a first digital visual representation of an insect for identification in real time, comparing the digital representation to a labeled dataset in real time, matching an identity and a life phase to the insect, and storing the identity and the life phase as an identified insect. The method includes determining a rise reading based on a fish behavior parameter. The method includes matching the identified insect and the rise reading in real time to one or more artificial flies and fishing presentations stored in a fly index and displaying a second digital visual representation of the one or more artificial flies and fishing presentations on a display of the mobile device.

### CROSS REFERENCE TO RELATED APPLICATIONS

The present application claims priority to U.S. Provisional Application No. 63/632,477 entitled “SYSTEMS AND METHODS FOR ARTIFICIAL FLY RECOMMENDATION” filed Apr. 10, 2024. The entire content of the above application are hereby incorporated by reference for all purposes.

### FIELD

The present application relates to systems and methods for automatically recommending an artificial fly in possession of a user for fly fishing based on an image of an insect, and further relates to a mobile application for executing the systems and methods.

### BACKGROUND/SUMMARY

Fly fishing is a specialized form of fishing which combines casting techniques and fishing lures, referred to as artificial flies or flies, to mimic the behavior of insects. One aspect of fly fishing includes fly selection. Typically, a fisherman may select a fly based on observations of the fishing site. For example, observations may include what prey the fish are feeding on at the site and whether the fish are feeding on the surface of the water or otherwise. The fisherman may select a fly from his or her tackle box based on the observations, for example, by attempting to match characteristics of observed prey to a fly. The fisherman may then attempt to cast or present the fly in a manner that mimics the behavior of the prey.

The sport appeals to fishermen across a broad range of experience, as even expert fly fishermen may find the process of fly selection and presentation challenging. Prey may include aquatic, terrestrial, and amphibious insects, crustaceans, and small fish. In the case of insects, the observed prey may be present in one or more life cycle phases at the location. For example, the fisherman may observe an adult life form of a prey insect, which may also be present in a larvae or pupa form, or vice versa. Much has been written on the subject of fly selection, including guides and other tools for determining which prey may be present at a location and matching flies to the prey. However, experienced fly fishermen know that many highly variable conditions may influence on which prey the fish feed on at any time. Even if the fisherman ably identifies prey at the fishing location, determining which fly to present to the fish may remain a challenge. For example, the fisherman may yet determine which prey or which characteristics of the prey to attempt to mimic, such as, the color, the size, the shape, or the movement or position in the water.

Some approaches for assisting fly fishermen include digital tools for insect identification. For example, a number of mobile applications exist that can identify an insect from a photographic image, or enable a user to identify an insect from a database using descriptive keywords and other parameters such as geolocation. Further, some digital tools include suggesting one or more flies based on an identified insect or other conditions. Further approaches include fishing kits with flies and corresponding instructions for selection, guidebooks, hatch charts, and identification keys.

However, the inventor herein has recognized shortcomings with such approaches. As one example, matching an artificial fly to an identified insect is not straightforward, and many factors may be considered before an appropriate fly and presentation technique are determined. As another example, thousands of fly patterns are known. A recommended fly may not be in the possession of the fisherman, and a workable alternative may not necessarily be obvious. Relatedly, even an expert fly fisherman may struggle to keep a mental map of a well-stocked fly box. In this case, determining whether or not they have in possession a recommended fly, or workable alternative, may be challenge. For novices and intermediate sportsmen, building and using a well-stocked fly box may take considerable time and effort.

In one example, the issues described above may be at least partially addressed by a method for automatically recommending one or more artificial flies from a tackle box based on a photographic image of an insect, and a mobile application for executing the method. The method uses a mobile phone camera to capture the photographic image of the insect at fishing location, uses image recognition to automatically identify the insect, obtains an observation of fish feeding behavior at the fishing location, and automatically recommends artificial flies that are in the possession of a user based on the identified insect and the fish feeding observation. The method recognizes the insect at the different life cycle phases relevant to the species (e.g., larva, dun, emerger, spinner, pupa, etc.) and categorizes the fishing fly suggestions based on life phase.

In this way, the disclosed approach provides real time recommendations based on actual fishing conditions while considering the specific artificial flies in possession of the user. By basing the recommendation on the actual fishing conditions and the fly inventory of the user, a technical advantage of reducing the processing load to generate accurate and relevant recommendations is provided, while relieving users of the guess work of fly selection. As a result, expert fisherman may catch more fish, and novices may develop fly fishing skills faster.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A shows an example of a fly recommendation system.

FIG. 1B shows a mobile application implementing the fly recommendation system.

FIG. 2 shows a high level flow chart of a method for automatically recommending a fly.

FIG. 3 shows an example of a method for determining flies in possession of a user.

FIG. 4 shows an example of a method for automatically identifying an insect.

FIG. 5 shows an example of a method for automatically recommending a fly based on a user fly box, an identified insect, and fish feeding behavior.

FIG. 6A shows example frames of a graphical user interface for matching an artificial fly and fishing presentation to an identified insect, and fish feeding behavior.

FIG. 6B shows example frames of the graphical user interface of FIG. 6A including interfaces displaying an artificial fly database, shopping list, and a user log.

FIG. 6C shows example frames of the graphical user interface of FIGS. 6A-B including examples of a fly recommendation interface.

### DETAILED DESCRIPTION

The following description relates to systems and methods for a fly fishing, and a mobile application configured to execute the disclosed systems and methods. In one example, the mobile application executes a process for automatically recommending artificial flies (also herein flies) in possession of a user based on an identified insect and a description of fish feeding behavior. In some examples, the mobile application includes processes for building a database representing artificial flies in possession the user. In some examples, additionally, or alternatively, the mobile application includes processes for building a tackle box or fly box that corresponds with the recommendations of the mobile application. The mobile application further includes processes for automatically identifying an insect based on image, for example, by using image recognition, including life phase of the identified insect. The mobile application further includes processes for determining fish feeding behavior, such as fish breaking the surface of the water, subsurface activity, or no surface activity. By matching the fish feeding behavior and the identified insect to one or more artificial flies in possession of the user, the mobile application may automatically determine one or more artificial flies to recommend to the user for fly fishing. In some examples, recommended flies may be displayed to the user including descriptions such as the insect and life phase mimicked by the fly, presentation technique, or other parameters.

The mobile application may further include processes for manual insect identification, where the user may view photos of insects and determine prey at the fishing location therefrom. The mobile application may automatically recommend flies based on the manually identified insect. The mobile application may further include a user log or journal, e.g., a fish log, where the user may record a fishing experience. For example, the user log may store a location, time and date of a fish caught, photos of the fish, species of the fish, insect identified at the location, a recommended artificial fly, a recommended fishing presentation, the artificial fly used, and so on. In some examples, the mobile application may include opportunities for partnerships or promotions with fishing outfitters, including links to purchase flies, fly fishing kits, or other merchandise. For example, the user may request to view recommended flies for purchase (e.g., not in possession of the user) based on an identified insect or other parameters, which the user may add to a shopping list. The mobile application may direct the user to an affiliated retailer for purchasing the flies on the shopping list.

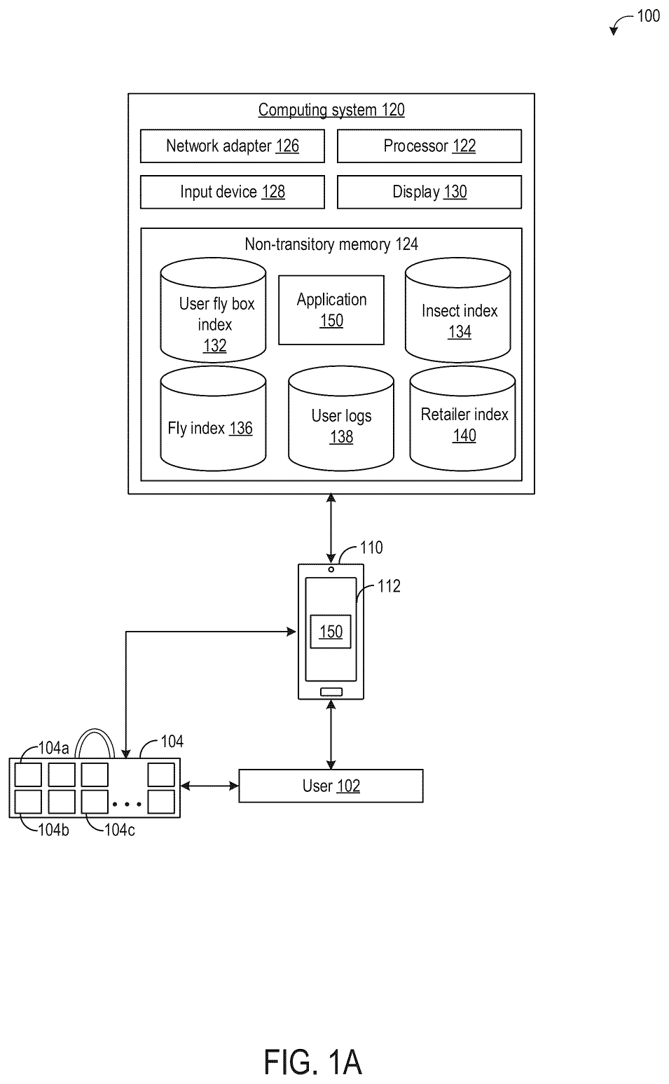

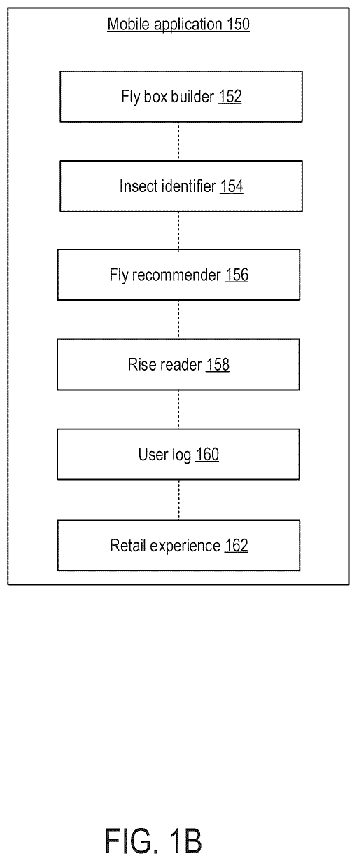

The following description provides examples of systems and methods that may enable a mobile application, such as mobile application 150 shown in FIGS. 1A-1B, to recommend artificial flies in possession of a user based on an identified insect, life phase, and a fish feeding behavior observation. The mobile application may be implemented by one or more computing systems, such as computing system 120 shown in FIG. 1A. Computing system 120 may include non-transitory memory, which may include instructions that when executed cause the processor to perform operations comprising one or more steps of one or more of the methods herein disclosed, such as methods 200, 300, 400, and 500 discussed in detail below. It will be understood that mobile applications, such as mobile application 150, may be implemented by more than one computing system, such as in a distributed computing scheme, wherein various functionalities of the mobile application may be enabled by a plurality of networked computing systems working in concert.

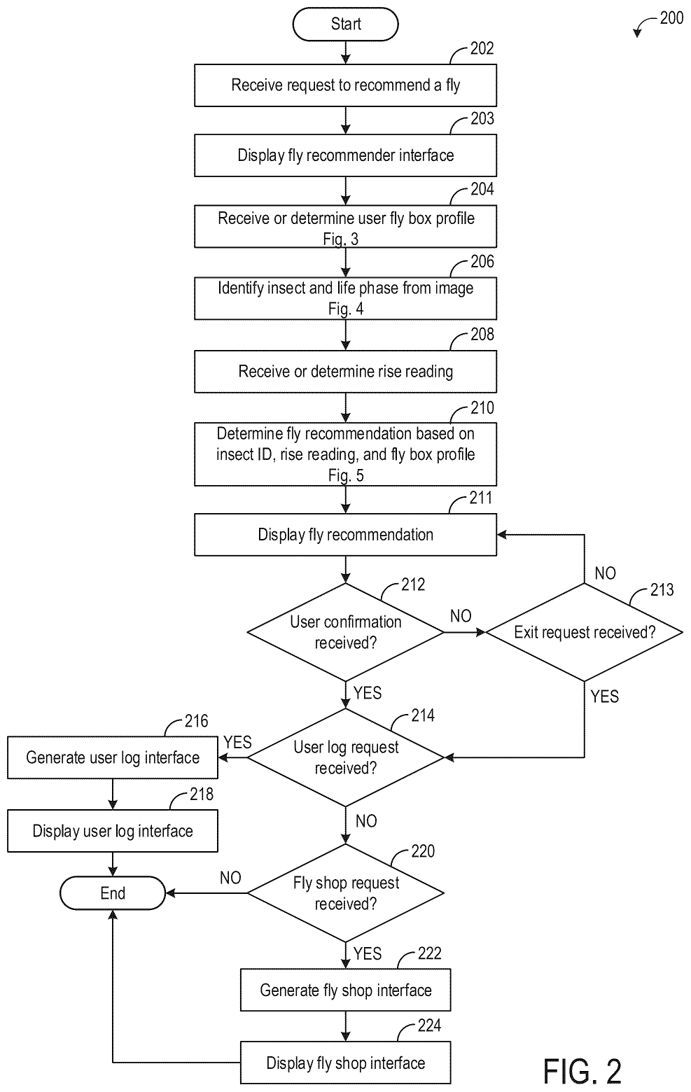

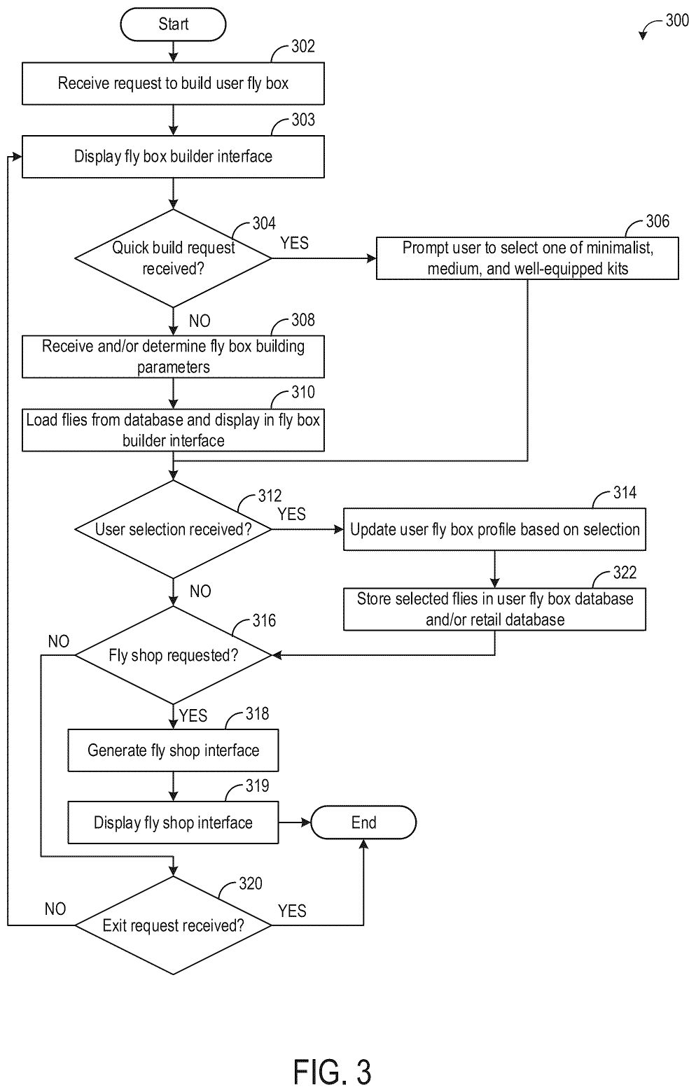

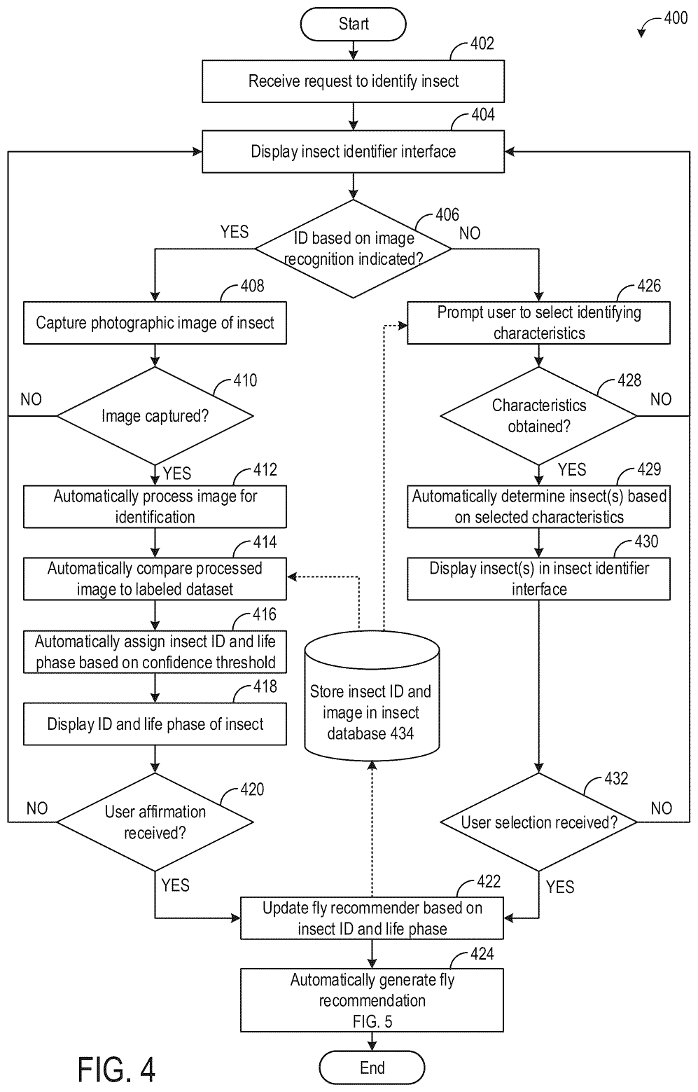

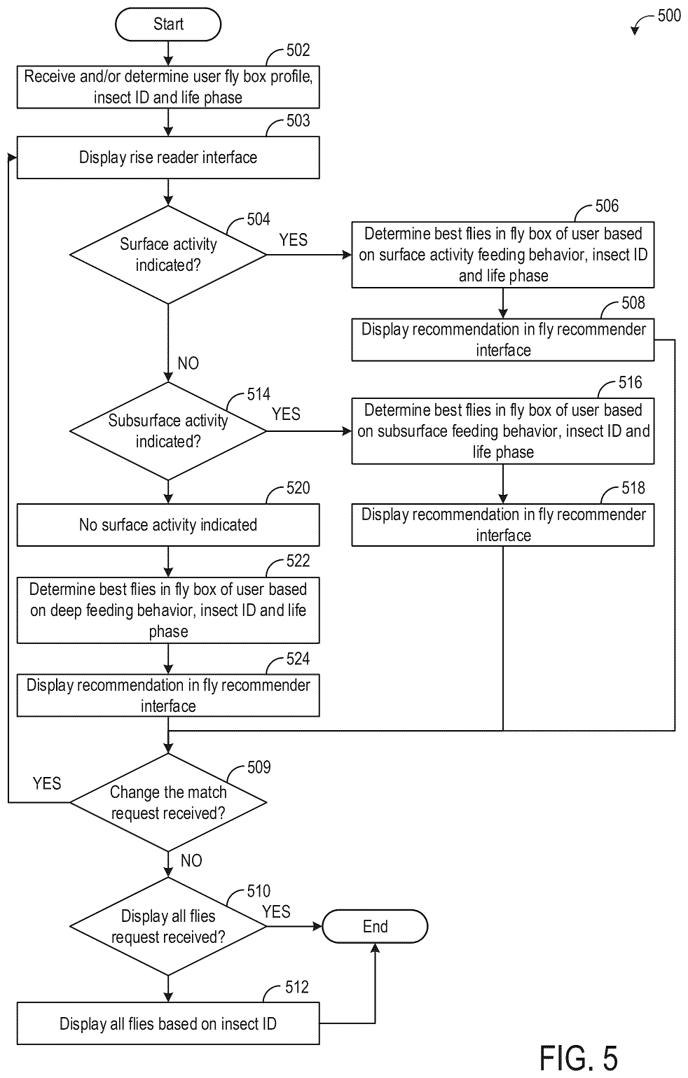

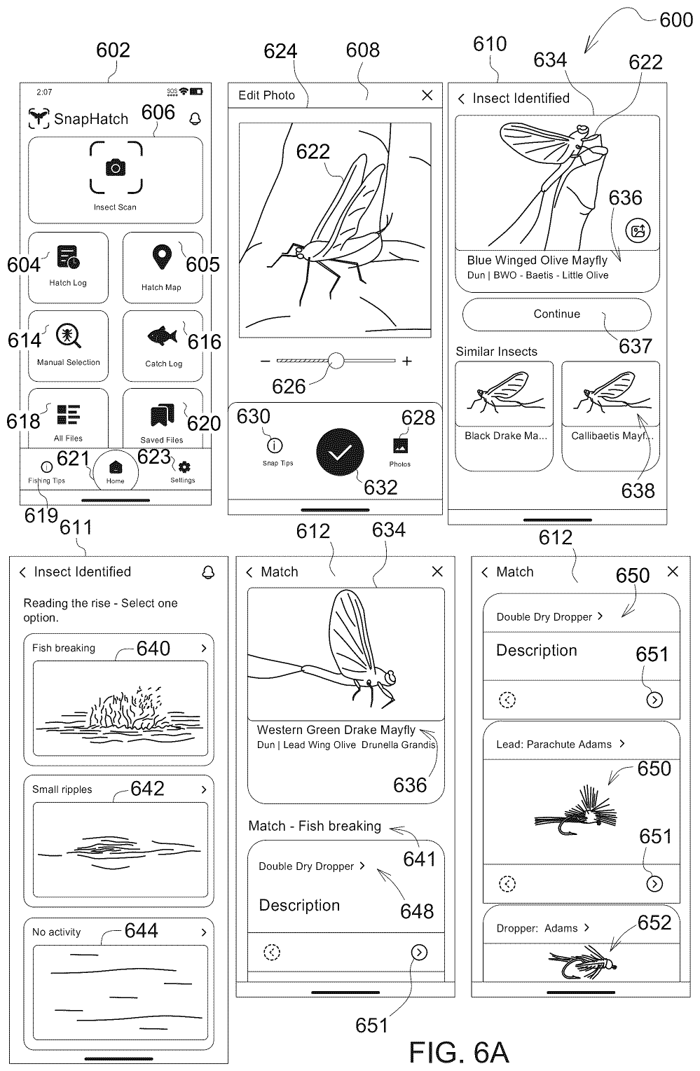

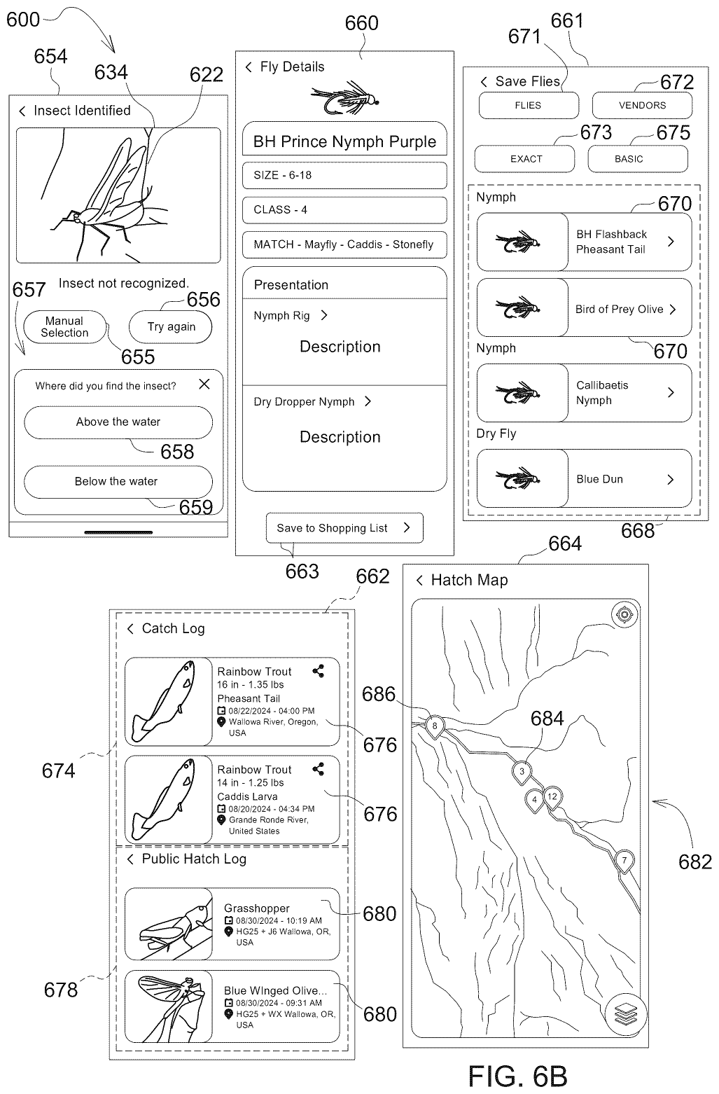

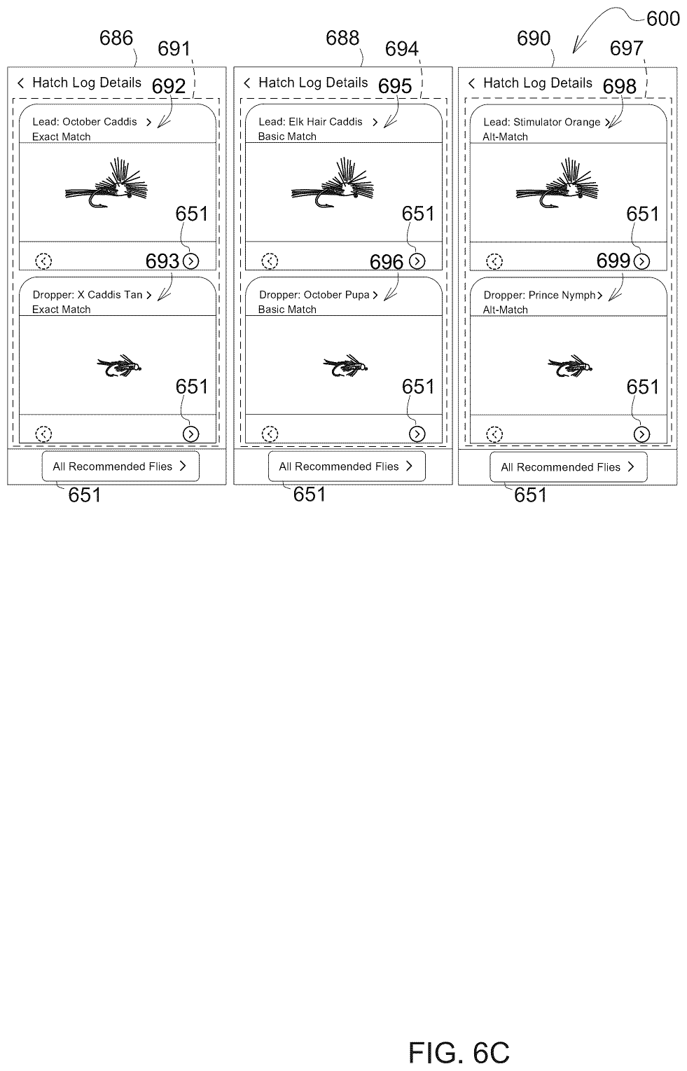

In a few examples, the mobile application may include a process for recommending artificial flies in possession of a user according to a method, such as the method 200 shown in FIG. 2. The mobile application may include a process for building a data set representing artificial flies in possession of a user according to a method, such as the method 300 shown in FIG. 3. FIG. 4 shows an example of a method by which the mobile application may identify an insect from an image based on image recognition. FIG. 5 shows an example method by which the mobile application may determine the best flies for fishing given an insect identity and life phase, fish feeding behavior observation, and the artificial flies in possession of the user. As used herein, the best flies may be understood to be the artificial flies that when used increase a likelihood that the user catches a fish at the fishing location. In one example, the best flies may be determined according to the systems and methods described herein, such as based on fishing conditions, one or more fly recommendation algorithms, and other factors. FIGS. 6A, 6B, and 6C illustrate example frames of a graphical user interface that may be rendered by a display of a user computing system as part of a process of recommending artificial flies on a mobile application.

FIG. 1A schematically shows an example fly recommendation system 100 including a mobile application 150 implemented by a computing system 120. The mobile application 150 may be configured to electronically communicate with external computing systems, such as one or more mobile devices, tablets, or personal computers. One or more or a plurality of users may interface with the mobile application 150 via one or more mobile devices, tablets, or personal computers. In one example, mobile application 150 may be configured to electronically communicate with one or more additional computing systems via a network such as the Internet, wherein the electronic communication may in one example comprise transmission and reception of data between the mobile application 150 and one or more additional computing systems. In one example, mobile application 150 may be configured for offline functionality.

The mobile application 150 may be accessed by a user 102 via a mobile device 110, e.g., a smart phone. The mobile application 150 may be a system for recommending artificial flies in possession of a user, such as the user 102, based on an identified insect, life phase, and fish feeding behavior observation. For example, the mobile application 150 may recommend one or more of a plurality of artificial flies 104a, 104b, 104c included in user fly box 104 (e.g., a tackle box, bait box) associated with the user 102. Example features of the mobile application 150 including processes for recommending artificial flies are described in more detail below and with reference to FIG. 1B.

Computing system 120 may implement the mobile application 150 alone, or in combination with other computing systems. In one example, computing system 120 may comprise a server. Computing system 120 includes processor 122, non-transitory memory 124, network adapter 126, input device 128, and display 130.

Processor 122 may include one or more physical devices configured to execute computer readable instructions stored in non-transitory memory. For example, processor 122 may be configured to execute instructions that are part of one or more applications, services, programs, routines, libraries, objects, components, data structures, or other logical constructs included in mobile application 150.

Network adapter 126 may comprise one or more physical devices associated with computing system 120, enabling transmission, and reception of data between computing system 120 and one or more additional computing systems. Network adapter 126 may enable computing system 120 to access a local area network, and/or the Internet, and exchange data therewith, such as data which may enable retrievable storage of user fly box profiles and matching between user fly boxes, detected insects, other fishing conditions, and fly recommendations.

Non-transitory memory 124 includes one or more physical devices configured to hold data, including instructions executable by the processor to implement the methods and processes described herein. When such methods and processes are implemented, the state of non-transitory memory 124 may be transformed—e.g., to hold different data. In some examples, non-transitory memory 124 may include one or more databases, such as a first database, a second database, and so on. These databases may represent logical partitions or specific memory locations within a single database. Additionally, or alternatively, non-transitory memory 124 may comprise a plurality of memory locations, such as a first memory location, a second memory location, a third memory location, a fourth memory location, a fifth memory location, and so on. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 124 includes the various files/routines/methods of mobile application 150 that when executed by processor 122 perform one or more of the steps herein described with reference to one or more of the disclosed methods. In one example, the files/routines/methods included in non-transitory memory 124 may be hard coded, thereby enabling the mobile application 150 to function offline. Computing system 120 may optionally include display(s), user input device(s), communication interface(s), and/or other components.

Non-transitory memory 124 optionally includes one or more or all of a user fly box index 132, an insect index 134, a fly index 136, user logs 138, and a retailer index 140. User fly box index 132 may be stored within non-transitory memory 124 of computing system 120, and may comprise a database or module used by computing system 120 in conjunction with the mobile application 150 to retrievably store data sets representing artificial flies in possession of one or more users of the mobile application 150. In one example, a data set representing artificial flies in possession of a user may be referred to as a fly box profile. For example, the user fly box index 132 may include a fly box profile representing the user fly box 104. As another example, additionally, or alternatively, user fly box index 132 may comprise a database or module used by computing system 120 in conjunction with the mobile application 150 to build a user fly box (e.g., a physical tackle box comprising a plurality of fishing flies) corresponding to one or more artificial fly databases of the mobile application 150. For example, the user may have one or more real fly boxes that include a plurality of artificial flies that match the plurality of artificial flies represented by the fly index 136 or a subset of the fly index 136. Insect index 134 may comprise a database or module containing information regarding identifying features of insects and life phases, images, and other data related to insects that are identifiable via mobile application 150 including, for example, one or more algorithms for automatically identifying insects using image recognition. Similarly, fly index 136 may comprise a database or module relating to artificial flies, including, for example, one or more algorithms for matching identified insects and/or other fishing conditions to artificial flies, identifying features of artificial flies (e.g., sizes), images, and other data related to artificial flies that may be referenced as part of a fly box profile, recommended for use, and/or purchased via the mobile application 150. For example, a body of water may be understood as a water column, and artificial flies may be categorized based on a position in the water column where in the flies are most effective, or an insect habitat position in the water column that the artificial flies mimic, or other fish feeding behavior-related categories. User logs 138 may be stored within non-transitory memory 124 of the computing system 120, and may comprise a database or module where users may record a fishing experience. Further optionally, retailer index 140 may be stored within non-transitory memory 124 of computing system 120, and may comprise a database or module relating to fly fishing outfitters, retailers, promotions and/or sponsor-related information on the mobile application 150.

Display 130 may comprise a monitor, touch screen, projector, or any other device known in the art of computers for enabling a user to observe or sense information rendered by a digital device. Computing system 120 may have stored within non-transitory memory 124 instructions for rendering data, such as mobile application 150 data, within a graphical user interface which may be displayed by display 130. Input device 128 enables a user to interface/interact with computing system 120, and may comprise one or more hardware devices, such as a touch screen, camera, keyboard, or other devices configured to transform user motions, gestures, sounds, or other user actions into an electronic form which may enable a user to input data, or transmit, select, modify, or otherwise interact with data or data structures stored in or displayed by computing system 120.

The mobile device 110 including display 112 may be one example of the input device 128 and the display 130. For example, the user 102 may interface/interact with computing system 120 using the mobile device 110. The mobile device 110 and other input devices of users may each include a processor, memory, communication interface, display, user input devices, camera, GPS/position sensors, and/or other components. In one example, information from mobile application 150 may be transmitted to mobile device 110 via a network connection (such as the Internet) between the mobile device 110 and the mobile application 150, for rendering within the display 112 implemented at the mobile device 110. The display 112 may be used to present a visual representation of the mobile application 150. This visual representation may take the form of a graphical user interface (GUI), an example of which is illustrated in FIGS. 6A-B.

Turning to FIG. 1B, mobile application 150 may optionally include one or more or a plurality of features (e.g., modules or programs) including one or more or all of a fly box builder 152, insect identifier 154, fly recommender 156, rise reader 158, user log 160, and retail experience 162. As illustrated in FIG. 1A, the various modules of the mobile application 150 may include instructions stored in non-transitory memory 124 that are executable by processor 122 of computing system 120. In other examples, the modules may be stored on multiple memories and/or executed by multiple processors distributed across multiple computing devices connected by a network.

Fly box builder 152 may include instructions and/or information relating to building datasets or fly box profiles representing artificial flies in possession of a user associated with the mobile application 150, such as the user 102 of FIG. 1A. In one example, the fly box builder 152 may generate one or more user interfaces which enable the user of the mobile application 150 to build one or more fly box profiles. The one or more fly box profiles may be stored in memory and retrieved for use in a fly recommendation request, a retail experience, or other use via the mobile application 150. In one example, the fly box builder 152 may display one or more of images, names, and descriptions of artificial flies, including the insect that the fly mimics, the color, the size, or other characteristics. The fly box builder 152 may further recommend artificial flies based on various parameters, such as user answers to prompts, execution of the fly recommender 156, or other processes of the mobile application 150. The interface(s) associated with the fly box builder 152 may allow the user to scroll through the displayed artificial flies and confirm that they have the artificial fly in their fly box, for example, by clicking a button, or otherwise indicating. As used herein, button may refer to any type of user input that provides a user a mechanism to select, confirm, or otherwise indicate a choice.

In some examples, the fly box builder 152 may include a plurality of preset fly box profiles and corresponding kits which allow the user to simply and quickly build a fly box and retrievably store the corresponding fly box profile in non-transitory memory. For example, preset fly box profiles and corresponding kits may include minimalist, medium, and well-equipped collections of artificial flies, which may range in one or more or all of artificial fly quantity, fly presentation skill level, complexity, target fish species, regional specificity, generality, or other variables. As one non-limiting example, a minimalist kit may include twenty-five artificial flies, a medium kit may include forty artificial flies, and a well-equipped kit may include eighty artificial flies. However, other arrangements may be imagined. In one example, the user may visit the fly box builder 152 to create, update, restock, review, or otherwise interact with one or more fly box profiles. In some examples, the user may maintain one or more fly box profiles, which may be selected for fly recommendations during a given fishing trip. An example method for building a fly box profile, which may be implemented by the fly box builder 152, is shown in FIG. 3.

Insect identifier 154 may include instructions and/or information relating to identifying insects. In one example, the insect identifier 154 may include processes for automatically identifying insects from a captured image using image recognition. For example, the insect identifier 154 may generate one or more user interfaces which enable the user to interact with and/or provide inputs that are used as part of the process to automatically identify an insect. For example, the processes and corresponding user interfaces may include one or more of capturing or acquiring a real time digital visual representation (herein also referred to as an image) of insect in real time, selecting a digital visual representation of an insect stored in memory of a mobile device or the mobile application 150, automatic image processing, automatic image matching to an insect database (e.g., insect index 134 in FIG. 1A), automatic determination of the insect identity, automatic determination of the life phase of the insect, and displaying the identity and life phase of the insect to the user.

In an additional, or alternative, example, the insect identifier 154 may include processes for manually identifying insects, and one or more user interfaces wherein the user may engage in the processes for manually identifying insects. In one example, the insect identifier 154 may generate prompts relating to identifying characteristics of the insect. For example, a prompt may request that the user input whether the insect is on the water surface or under the water surface. The insect identifier 154 may display one or more of images, names, and descriptions of insects based on the input. Further, the insect identifier 154 may display previously identified insects. The interface(s) associated with the insect identifier 154 may allow the user to scroll through the displayed insects and confirm the identification, for example, by clicking a button, or otherwise indicating. An example method for automatically identifying an insect, which may be implemented by the insect identifier, is shown in FIG. 4.

Fly recommender 156 may include instructions and/or information relating to recommending artificial flies. In one example, the fly recommender 156 may include processes for automatically recommending flies in possession of a user based on fishing conditions and one or more corresponding user interfaces which enable the user interact with the processes for automatically recommending artificial flies. As one example, the fishing conditions may include an identified insect, life phase of the identified insect, and a fish behavior observation, such as an observation of fish feeding behavior. In response to a request to recommend a fly, the fly recommender 156 may generate one or more of the interfaces of the fly box builder 152, the insect identifier 154, and the rise reader 158, and render the one or more interfaces on the display of the user's mobile device. In additional, or alternative, examples, fishing conditions may include fewer, more, or different conditions, such as, but not limited to, altitude, geography, location, GPS data, weather, time of year, user settings, or others, and the fly recommender 156 may execute one or more additional, or alternative, processes and user interfaces to corresponding thereto.

In one example, the rise reader 158 may include one or more processes for determining real time fishing conditions and one or more corresponding user interfaces. One example of real time fishing conditions may include a fish behavior parameter or fish feeding habits at a fishing location, also herein referred to as reading the rise. As used herein, reading the rise may include observations of feeding behavior of fish at a fishing location where the user is requesting a fly recommendation from the mobile application 150. For example, a position in the water column, e.g., relatively lower or higher, where the fish are feeding may be a factor in determining a fly recommendation. The rise reader 158 may present (e.g., display) one or both of images and descriptions of fish feeding behavior and prompt the user to select the feeding behavior most similar to the observed behavior at the fishing location, for example, by clicking a button or otherwise indicating. For example, the images may include animated images, such as a GIF, still images, or both. Additionally, or alternatively, the rise reader 158 may include processes for automatic detection of fish feeding behavior, such as, by matching photographic images or video of the fishing location to a database of feeding behavior images and video.

The fly recommender 156 may determine one or more recommended artificial flies based on the fishing conditions and display the recommendations to the user. For example, the method may include matching the fishing conditions and the identified insect to one or more fishing presentations and artificial flies. The fly recommender 156 may determine and display additional recommendations if requested. For example, the user may request to see recommended flies that are not in included in the fly box profile of the user, which may be added to a shopping list. Example methods for recommending an artificial fly, which may be implemented by the fly recommender 156, are shown in FIGS. 2 and 5.

In one example, the fly recommender 156 may weight factors to determine one or more recommended flies. Weighted analysis may increase recommendation accuracy. For example, upon receipt of a user request to recommend a fly, the fly recommender 156 and associated algorithms may assign a weight to certain factors based on the fishing conditions, and in other circumstances, the factors may be weighted differently. The weights may be assigned automatically. As an example, the fly recommender 156 may determine a fishing presentation based on the fish feeding behavior observation and the life phase of the insect, where a greater weight is assigned to the fish feeding behavior observation than the life phase of the insect when determining the fishing presentation. The fly recommender 156 may select one or more artificial flies from the artificial fly database based on the determined fishing presentation and the insect identity. As another example, the identified insect may be assigned a first weight, a first fishing condition (e.g., a rise reading or other condition) assigned a second weight, and the fly recommender 156 may determine the fly recommendation based on the first weight, the identified insect, the second weight, and the first fishing condition.

As another non-limiting example, a first set of fishing conditions may include a local altitude (e.g., a first fishing condition) greater than a threshold (e.g., altitude ≥6000 feet), an identified insect in the adult life phase, and surface fish feeding behavior. Based on the first set of fishing conditions, the fly recommender 156 may assign a greater weight to the altitude than the insect identity and feeding behavior in determining the one or more fly recommendations. A second set of fishing conditions may include the local altitude (e.g., the first fishing condition) less than the threshold (e.g., altitude <6000 feet), the same identified insect in the adult life phase, and surface fish feeding behavior. Based on the second set of fishing conditions, the fly recommender 156 may assign an equal weight to the altitude, the insect identity, and feeding behavior in determining the one or more fly recommendations. In another example, a greater weight may be assigned to the fish feeding behavior than the insect identity, the life phase of the insect, or other factors, for determining the fly recommendation.

User log 160 may include instructions and/or information relating to creating, storing, and viewing fishing experiences associated with the mobile application 150. In one example, the user log 160 may generate one or more user interfaces which enable a user to input data relating to a fishing experience including, for example, one or more images of a caught fish, a date, time, and location of the catch, body of water, identified insect, artificial fly used, the species of fish, and other notes. In another example, additionally, or alternatively, the user log 160 may automatically store fishing experiences, such as a photographed insect, corresponding identity and matched fly or flies, and the date, time, and location of the fishing experience. Additionally, or alternatively, the user log 160 may generate visual content based on the fishing experiences for display via a user interface of the mobile application. The interface(s) associated with the user log 160 may allow the user to scroll through or otherwise search (e.g., using keywords) an image gallery of caught fish, identified insects, and artificial flies, as well as review notes associated with fishing experiences. In some example, the user log 160 may include an option to make one or more logged fishing experiences public, e.g., publically accessible, to other users of the mobile application 150. In some examples, the public logged information may be accessed in real time by other users. In some examples, the user log may organize and retrievably store multiple data types, such as image data, geographic/GPS data, date/time, etc., and integrate the multiple data types into unified visual representation. For example, the user log 160 may display logged information, such as, but not limited to, insect image, the identified insect, the date, time and location on a map.

Retail experience 162 may include instructions and/or information relating to retail, promotional, or sponsor-related experiences on the mobile application 150. In one example, the retail experience 162 may generate one or more user interfaces which enable a user to create a shopping list of recommended artificial flies. In another example, the retail experience 162 may generate one or more user interfaces which enable a user to purchase recommended artificial flies from one or more retailers affiliated with the mobile application 150. In one example, the interface(s) associated with the retail experience 162 may allow the user to scroll through or otherwise search (e.g., using keywords) through one or more databases (e.g., catalogues) including artificial flies for purchase, fly fishing trips, guide experiences, or other promotions offered through one or more retailers affiliated with the mobile application 150.

Implementation of a mobile application for recommending artificial flies (hereinafter a fly) in a possession of a user is shown in methods 200, 300, 400, and 500 in FIGS. 2-5, respectively. The method 200, and the other methods disclosed herein, provide artificial fly and fishing presentation recommendations based on real time fishing conditions. In one example, the methods 200, 300, 400, and 500 may be executed as part of a fly recommendation system, such as the fly recommendation system 100 described with reference to FIG. 1A. In one example, the methods 200, 300, 400, and 500 may be stored in non-transitory memory of a computing system implementing a mobile application, such as computing system 120, and one or more, or all, of the steps of the methods 200, 300, 400, and 500 may be automatically executed by the mobile application, or by one or more subcomponents, modules, databases, or subsystems of the mobile application. In one example, the mobile application may be the mobile application 150 described with reference to FIGS. 1A-1B. Method 200 is a flowchart describing a high-level process for automatically recommending a fly. Method 300 is a flowchart describing a method for building a user fly box profile. Method 400 is a flow chart describing a method for identifying an insect based on image recognition. Method 500 is a flowchart describing a method for automatically recommending a fly in possession of a user based on an identified insect and a fish feeding behavior observation.

Turning now to FIG. 2, a flow chart illustrating the method 200 for automatically recommending an artificial fly is shown. The method 200 may initiate in response to a mobile application, such as the mobile application 150, determining a user has accessed a startup screen associated with the mobile application.

At 202, the method 200 may include receiving a request to recommend a fly. For example, the user may access the mobile application through a mobile device such as a tablet or mobile telephone. Once accessed, the user may select from a menu of the mobile application to recommend a fly. For example, the user may click a button or otherwise indicate the request to recommend a fly. At 203, the method 200 may include displaying a fly recommender interface, such as an interface of the fly recommender 156 in FIG. 1B.

At 204, the method 200 may include receiving or determining a user fly box profile. In one example, the method 200 may receive a user fly box profile, for example, in response to the user selecting a stored user fly box profile from a menu of the fly recommender interface. For example, one or more fly box profiles may be stored in the user fly box index 132 in FIG. 1A. The mobile application may display stored profiles for selection by the user. Alternatively, the method 200 may determine a fly box profile, for example, in response to the user requesting to build a new fly box profile. In such an example, the method 200 may include displaying a fly box builder interface, such as one or more interfaces of the fly box builder 152 in FIG. 1B, and executing corresponding processes with reference to one or more databases or modules, such as the user fly box index 132 and the fly index 136 in FIG. 1A, and the method 300 described below with reference to FIG. 3.

At 206, the method 200 may include automatically identifying an insect from an image based on an image recognition algorithm. The method 200 may include displaying an insect identifier interface, such as one or more interfaces of the insect identifier 154 in FIG. 1B, and executing corresponding processes with reference to one or more databases or modules, such as the insect index 134 in FIG. 1A, and the method 400 described below with reference to FIG. 4.

For example, at 206, the method 200 may include acquiring, with a camera of a mobile device, a first digital visual representation of an insect for identification in real time. The method may include comparing the first digital visual representation to a labeled dataset, matching an identity and a life phase to the insect and storing the identity and the life phase as an identified insect in an insect index.

At 208, the method 200 may include receiving or determining a fish feeding behavior observation. In example, the method 200 may include displaying a rise reader interface, such as one or more interfaces of the rise reader 158 in FIG. 1B, and executing corresponding processes.

For example, at 208, the method 200 may include determining a rise reading based on a fish behavior parameter, such as fish feeding behavior. The mobile application may display example one or both of images and descriptions of fish feeding behavior for selection by the user. The user may select the example image and/or description which is most similar to the observed fish feeding behavior at the fishing location. As a few examples, the mobile application may display one or more images and/or descriptions including fish breaking the surface, small ripples but no fish visible, and no surface activity. Alternatively, the method 200 may automatically determine the fish feeding behavior, for example, by matching photographic images or video of the fishing location to a database of fish feeding behavior images and video. Additionally, or alternatively, the fish feeding behavior observation may be one example of a fish behavior parameter. In a few other non-limiting examples, the fish behavior parameter may include breeding behavior, migration patterns, predatory style, and so on.

At 210, the method 200 may include automatically determining a fly recommendation based on the identified insect, the fish feeding behavior determination, and the user fly box profile. For example, the method 200 may include executing a fly recommendation algorithm with inputs including the identified insect, the life phase of the identified insect, fish feeding behavior, and the user fly box profile. The method 200 may include referencing one or more databases or modules, such as the user fly box index 132, the insect index 134, and the fly index 136, and executing corresponding processes, such as the method 500 described below with reference to FIG. 5. For example, at 210, the method 200 may include matching the identified insect and the rise reading to one or more artificial flies and fishing presentations stored in a fly index (e.g., fly index 136 in FIG. 1A). In other examples, the fly recommendation algorithm may base fly recommendations on fewer, more, or different inputs, and corresponding sub-processes. As a few non-limiting examples, inputs may include GPS data, weather, time of year, user settings, user log data, public user log data, and others. Further, as noted above, the fly recommendation algorithm may automatically assign weights to the inputs when determining recommended flies. The assigned weights may vary based on the fishing conditions or other factors. In some examples, the fly recommendation may include the artificial fly or flies and fishing presentation, such as casting technique, line management, fly drift, angle or other movement on or in the water.

At 211, the method 200 may include displaying one or more artificial fly recommendations. In other words, the method 200 may include rendering a digital visual representation (e.g., a second digital visual representation) of the recommended artificial flies including one or more of images, drawings, descriptions, presentation technique, and other associated data. In one example, the artificial fly recommendations may be presented as a simplified menu with options to view more details. In one example, the user may scroll through the fly recommendation menu and select an artificial fly to fish with. For example, the user may click a button or otherwise indicate confirmation of the artificial fly recommendation.

At 212, the method 200 may include determining whether user confirmation of an artificial fly selection is received. In response to determining an artificial fly selection is received, the method 200 may determine whether the user log is requested at 214. In response to determining an artificial fly selection is not received, the method 200 may include determining whether an exit request is received at 213. For example, the method 200 may include determining whether the user has selected an exit button associated with the mobile application. In response to determining the user has not requested to exit, the method 200 may continue to display the fly recommendation at 211.

In response to determining the user log is requested at 214, the method 200 may include generating a user log interface at 216, such as one or more of the interfaces associated with the user log 160 in FIG. 1B, and displaying the user log interface at 218.

In response to determining the user log is not requested at 214, the method 200 may include determining whether a fly shop request is received at 220. In response to determining a fly shop request is received, the method 200 may include generating a fly shop interface at 222, such as one or more of the interfaces associated with the retail experience 162 in FIG. 1B, and displaying the fly shop interface at 224.

Turning now to FIG. 3, a flow chart illustrating the method 300 for building a user fly box profile is shown. The method 300 may initiate in response to a mobile application, such as the mobile application 150, determining a user has accessed a startup screen associated with the mobile application.

At 302, the method 300 may include receiving a request to build a fly box profile. For example, as detailed above, the user may access the mobile application through a mobile device such as a mobile telephone, e.g., a smart phone, and select from a menu of the mobile application to build a fly box profile. As another example, the request to build a fly box profile may be received as part a fly recommendation process, e.g., via the fly recommender 156 in FIG. 1B. For example, the request to build a fly box profile may be received in response to the user indicating that they do not have a stored fly box profile. At 303, the method 300 may include displaying a fly box builder interface, such as an interface of the fly box builder 152 in FIG. 1B.

At 304, the method 300 may include determining whether a quick build request is received. In one example, the method 300 may determine a quick build request is received in response to an indication from the user, such as the user clicking a button or otherwise indicating. Selecting quick build enables the user to build a fly box profile from a preset profile corresponding to a fly kit, as described above.

At 306, in response to determining a quick build request is received, the method 300 may include prompting the user to select one of a minimalist kit, medium kit, and a well-equipped kit, which may be categorized based on the number of flies in the kit. For example, the method may include retrieving data corresponding to the preset kits from a database, such as the fly index 136 in FIG. 1A, generating an interface to display the kits, and displaying the preset kits of artificial flies. In other examples, the user may be prompted to select from profiles and corresponding kits categorized by another parameter or parameters. For example, quick build profiles and corresponding kits may be categorized by region, body of water, time of year, complexity, skill level, and so on. In some examples, preset or quick build profiles provide technical efficiency in data storage and retrieval. Further, preset or quick build profiles reduce computational overhead compared to manual entry.

At 308, in response to determining a quick build kit is not received, the method 300 may include receiving and/or determining a plurality of fly box profile building parameters. For example, the method 300 may prompt the user to provide input for generating a menu of artificial flies to suggest and display for selection. For example, the user may select one or more classifications of fly patterns, presentation techniques, insects, insect life phases, colors, sizes, geographic locations, time of year, and so on. Additionally, or alternatively, the method 300 may automatically generate a menu without user input, or may generate a menu based on sensor input, such as GPS data.

At 310, the method 300 may include loading artificial flies from a database, such as the user fly index 136 in FIG. 1A, and displaying the artificial flies in the fly box builder interface for user selection. In one example, the fly box builder interface may include a selectable button, box, or similar, associated with each artificial fly. The user may click the button, check the box, or otherwise indicate selection of one or more artificial flies to add to the fly box profile.

At 312, the method 300 may include determining whether a user selection is received. For example, the method 300 may determine a user selection is received in response to the user clicking a button to update the fly box profile.

At 314, the method 300 may include updating the user fly box profile based on the selection. For example, at 322, the method 300 may include storing selected artificial flies in a database, such as the user fly box index 132 in FIG. 1A. Additionally, or alternatively, the method 300 may include storing the selection as shopping list, such as a shopping list stored in the retailer index 140 in FIG. 1A.

At 316, the method may include determining whether a fly shop request is received at 316, such as in response to the user clicking a button to visit the fly shop. In response to determining a fly shop request is received, the method 300 may include generating a fly shop interface at 318, such as one or more of the interfaces associated with the retail experience 162 in FIG. 1B, and displaying the fly shop interface at 319. In some examples, the fly shop interface may link to one or more or a plurality of outside vendors. In other examples, the mobile application may include an integrated shop where uses can make purchase directly within the mobile application without navigating to external vendors. As one example, the user may visit the fly shop to purchase one or more artificial flies and/or preset kits saved to the shopping list. In this way, the user may build a fly box profile from recommended flies, which may be used upon receiving the purchased artificial flies. The approach allows users to build a real tackle box corresponding to the plurality of artificial flies that are used in the fly recommendation algorithm of the mobile application.

In response to determining a fly shop request is not received, the method 300 may include determining whether an exit request is received at 320. For example, the method 300 may include determining whether the user has selected an exit button associated with the mobile application. In response to determining the user has not requested to exit, the method 300 may include displaying the fly box builder interface at 303.

Turning now to FIG. 4, a flow chart illustrating the method 400 for automatically identifying an insect is shown. The method 400 may initiate in response to a mobile application, such as the mobile application 150, determining a user has accessed a startup screen associated with the mobile application. In some examples, one or more elements of the method 400 may be implemented without network connectivity through local data storage and processing. The online/offline capability provides the technical benefit of ensuring recommendations even in remote fishing locations without network access.

At 402, the method 400 may include receiving a request to identify an insect. As one example, the request to identify an insect may be received as part a fly recommendation process, e.g., via the fly recommender 156 in FIG. 1B. As another example, the user may select from a menu of the mobile application to identify an insect. At 404, the method 300 may include displaying an insect identifier interface, such as an interface of the insect identifier 154 in FIG. 1B.

At 406, the method 400 may include determining whether a request to identify an insect based on image recognition is received. In one example, the method 400 may determine a request to identify an insect based on image recognition is received in response to an indication from the user, such as the user clicking a button, accessing the camera of the mobile phone via the insect identifier interface, or otherwise indicating. Generating an identification based on image recognition enables the user to obtain an insect identification automatically from a submitted image of the insect, and without additional input or specialized knowledge.

At 408, in response to determining an identification based on image recognition request is received, the method 400 may include capturing a photographic image of the insect. In one example, the method 400 may include automatically capturing a photographic image in real time using a camera of the input device associated with the mobile application. In one example, the method 400 may include prompting the user to obtain a photographic image of the insect, such as by operating the camera of the input device. As another example, the user may select and submit a stored image.

At 410, the method 400 may include determining whether an image is captured. In one example, the method 400 may determine an image is captured in response to an indication from the user, such as the user clicking a “capture” button or otherwise indicating.

At 412, the method 400 may include automatically processing the image for identification. For example, the method 400 may include adjusting the image data to reduce or remove noise, adjusting parameters such as brightness or contrast to standardize the image data, and extracting relevant features from the image data such as edges, patterns, color, or other features.

At 414, the method 400 may include automatically comparing the processed image to a labeled dataset including insect images and associated data, and executing a detection and classification process with reference to one or more machine learning models trained on the labeled dataset. The labeled dataset and corresponding trained machine learning model may be stored and accessed via the insect index 134 in FIG. 1A. In one example, the labeled dataset may include insect images and associated data representing each life phase. As a few non-limiting examples, the labeled dataset may include midges and caddisflies as larvae, pupa, and adults. Mayflies may be included as nymphs, emergers, duns, and spinners. Stoneflies may be included as nymphs and adults. Scuds, sowbugs, and water boatmen, and terrestrial prey, such as grasshoppers, ants, beetles, and cicadas, may be included as adults. As a further example, the labeled dataset may include a plurality of images of insects and life cycle phases, and corresponding taxonomic classification (e.g., formal name or other common identifier). For example, the plurality of images may include insects photographed at various angles (e.g., rear, front, top, bottom), at various scales, in a variety of light qualities, partial images, and so on. For example, the associated data may include the insect identity and the life phase, a confidence score, location, date, or other data.

At 416, the method 400 may include automatically assigning an insect identity and life phase based on a confidence threshold. In one example, the insect identity may include the genus and species of the insect and the phase of the life cycle of the insect. In other examples, the insect identity may include a subspecies, a morphotype, common name, or other commonly used name. For example, the machine learning model may determine a confidence score for the assigned insect identity and compare the confidence score to the confidence threshold to determine a reliability of the identification. In some examples, the method may include prompting the user to submit a new photo, one or more additional photos, or another input in response to a lower than threshold confidence score. In one example, the confidence threshold may be a non-zero, positive value threshold. The value may be determined via calibration operation. In some examples, the identified insect may be added to the labeled dataset in response to the confidence score exceeding the confidence threshold. In response to the confidence score not exceeding the confidence threshold, alternative options may be displayed such as providing another image of the insect (e.g., a second real time digital visual representation) for identification or identifying the insect manually.

At 418, the method 400 may include displaying the identified insect in the insect identifier interface. For example, the method may include rendering a third digital visual representation of the identified insect on the display of the mobile device of the user. The third digital visual representation may include a digital image of the insect stored in a memory location, such as the insect index 134 in FIG. 1A.

At 420, the method 400 may include determining whether a user affirmation is received. For example, the user may click a button or otherwise indicate affirmation of an identified insect. In response to determining user affirmation is not received, the method 400 may include returning to 404 to display the insect identifier interface.

In response to determining user affirmation is received, the method 400 may include updating the fly recommender based on the identified insect and life phase at 422. At 434, the method 400 may include storing data associated with the identified insect, such as, for example, one or more of the image (e.g., the first digital visual representation), the identity, the life phase, the confidence score, location, date, or other data in the insect index 134 in FIG. 1A, which may be incorporated into training of one or more machine learning models.

At 424, the method may include automatically recommending an artificial fly based on the identified insect and life phase, such as described below with reference to FIG. 5.

Returning to 406, in response to determining a request to identify an insect based on image recognition is not received, the method 400 may include prompting the user to select identifying characteristics at 426. For example, the method 400 may include prompting the user to provide input to one or more or a series of questions that may be used for generating a menu of insects to display for selection. For example, a prompt may request that the user input whether the insect is on the water surface or under the water surface. In some examples, the insects and corresponding identifying characteristics may be stored and accessed via the insect index 134 in FIG. 1A.

At 428, the method may include determining whether identifying characteristics are obtained. For example, the method may determine identifying characteristics are obtained in response to the user submitting an answer to one of aforementioned prompts, by clicking a button or otherwise indicating. In response to determining identifying characteristics are not obtained, the method may return to 404 to display the insect identifier interface.

In response to determining identifying characteristics are obtained, at 429, the method 400 may include automatically determining one or more insects based on the selected characteristics.

At 430, the method 400 may include displaying one or more of images, names, and descriptions of insects based on the input. Further, in some examples, such as in response to user input, GPS or other sensor data, or other parameters, the method 400 may include displaying previously identified insects. The display may be presented as menu, where the user may scroll through the displayed insects and select an identification, for example, by clicking a button, or otherwise indicating.

At 432, the method 400 may include determining whether a user selection is received. In response to determining a user selection is not received, the method 400 may include returning to 404 to display the insect identifier interface.

In response to determining the user selection is received, the method 400 may include updating the fly recommender (e.g., fly recommender 156 in FIG. 1B) based on the identified insect and life phase at 422, and recommending a fly based on the identification at 424.

In one example, the online and offline functionality may be supported where the image recognition algorithm is implemented in a distributed computing architecture that selectively operates in a first online mode utilizing networked computing systems for processing tasks when network connectivity is available and a second offline mode when network connectivity is not available. The second offline mode may include utilizing local data storage and processing capabilities when network connectivity is unavailable. In some examples, the second offline mode maintains image recognition and fly recommendation functionalities through cached insect identification models and fly matching algorithms stored locally.

In this way, by using image recognition, the disclosed approach may identify insects in real time, including the life phase, for use artificial fly recommendations. By applying computer vision and image recognition algorithms to acquire an image of an insect for identification in real time, compare the image to a labeled dataset, and match the identity and the life phase to the insect, the system eliminates manual steps. Moreover, using computer vision techniques through detecting edges, patterns, and colors, and matching processed image features against the insect database to determine insect identity and life phase provides more accurate and rapid identification compared to human visual assessment.

Turning now to FIG. 5, a flow chart illustrating the method 500 for automatically recommending an artificial fly based on a user fly box, an identified insect, and a fish feeding behavior observation is shown. The method 500 may operate as part of a fly recommendation system, such as the fly recommendation system 100 in FIG. 1A. The method 500 may execute in response to a mobile application, such as the mobile application 150, determining a user has requested a fly recommendation, such as via the fly recommender 156 in FIG. 1B, as described above with reference to the method 200 in FIG. 2. Further, one or more corresponding user interfaces of the fly recommender 156, which enable the user interact with the processes for automatically recommending artificial flies, may be displayed during the execution of the method 500. The method 500 may include referencing one or more databases or modules, such as the user fly box index 132, the insect index 134, and the fly index 136, and executing corresponding processes.

At 502, the method 500 may include receiving and/or determining a user fly box profile, and an identified insect and life phase of the identified insect. In one example, the method 500 may receive the user fly box profile and the identified insect from the memory of the mobile application, for example, by respectively accessing the user fly box index 132 and the insect index 134 stored in non-transitory memory 124 in FIG. 1A. As another example, the method 500 may determine the user fly box profile, for example, in response to determining a stored user fly box profile is unavailable or otherwise not received. In such an example, the method 500 may include directing the user to build a fly box profile, such as via the fly box builder 152 in FIG. 1B, and by executing one or more corresponding methods, such as described above with reference to FIG. 3. In one example, the method 500 may determine an identification and life phase of an insect, for example, in response to determining a stored identified insect unavailable or otherwise not received. Similarly, the method 500 may include directing the user to identify an insect, such as via the insect identifier 154 in FIG. 1B, and by executing one or more corresponding methods, such as described above with reference to FIG. 4.

Additionally, or alternatively, the method 500 may include receiving an artificial fly dataset. In such an example, the user fly box profile may comprise an example of an artificial fly dataset (e.g., a first artificial fly dataset). Other examples of artificial fly datasets may include a database of all artificial flies stored in non-transitory memory, such as the fly index 136 in FIG. 136, or subsets of artificial flies (e.g., a second artificial fly dataset) grouped based on various conditions, such as based on fishing conditions, user preferences, and so on. As one example, subsets of artificial flies may include Exact Match flies and Basic Match flies. In such an example, users may input selection of one of the subsets (Exact or Basic) to the fly recommender interface and the fly recommendations may be suggested from the selected subset.

At 503, the method 500 may include displaying a rise reader interface, such as an interface of the rise reader 158 in FIG. 1B. As one example, the method 500 may include displaying one or both of images and descriptions of fish feeding behavior and prompting the user to select the feeding behavior most similar to the observed behavior at the fishing location, for example, by clicking a button or otherwise indicating. Example feeding behavior images or descriptions may include surface activity, such as fish breaking the water surface, subsurface activity, such as small ripples on the water surface without visible fish, and no surface activity, such as an unbroken or minimally disturbed water surface.

At 504, the method 500 may include determining whether surface activity is indicated. In one example, the method 500 may determine surface activity is indicated based on the response of the user to selecting the description of surface activity as representative of the observed behavior at the fishing location.

In response to determining surface activity is indicated, the method 500 may include determining the best flies in the fly box of the user based on surface activity feeding behavior and the identified insect and life phase at 506. For example, the method 500 may include determining the best three flies in the fly box of the user, the best five flies, or other number. In one example, the method 500 may include determining a recommendation including one or more artificial fly presentations and corresponding artificial flies. As another example, the method 500 may include recommending an exact insect imitation, a basic imitation, a best fly presentation, and an alternate fly presentation. In other examples, more or fewer recommendations may be presented. In one example, the exact insect imitation may be an artificial fly that corresponds to both the identity and the life phase of the identified insect. The basic imitation may be the artificial fly that corresponds to one of the identity or the life phase of the identified insect. As another example, the exact insect imitation may provide users with an exact match to fish for the insect identified and the reading the rise option selected. The basic imitation may provide recommendations based on a smaller list of versatile overlapping and alternate flies that can be used on a variety of insects identified and reading the rise option selected. The artificial fly presentation recommendation may be made based on the life cycle of the identified insect and the fish feeding behavior determination. Greater weight may be given to the fish feeding behavior determination as such information may reveal the life cycle of insects that the fish are currently feeding on. Once the artificial fly presentation is determined, the method may use the identified insect and life cycle to determine the corresponding one or more flies. The recommended flies may or may not match the life cycle of the identified insect. Each fly may be assigned a rank based on the presentation that will be used to fish, the identified insect, and the life cycle of the insect. As one example, the method may automatically identify an insect as a stonefly nymph and determine the fish are breaking the surface of the water. Such behavior may suggest the fish are targeting insects higher in the water column. In response to such example fishing conditions, as a non-limiting example, the recommended fly may be a dry dropper nymph presentation with a stonefly dry fly and a dropper nymph.

At 508, the method 500 may include displaying the recommendation in the fly recommender interface. For example, as described above with reference to the method 200, the method 500 may include generating a visual representation of the recommended artificial flies including one or more of images, drawings, descriptions, the presentation technique, and other associated data. In one example, the display may include functionality which enables the user to select a recommended fly and view more details. In other examples, the method may include displaying the single best fly, the best five flies, or other number of recommendations. In others examples, a user may set a number of flies to recommend. In some examples, the display may include one or more user interface elements where the user can confirm a selection of the fly recommendation, e.g., the one or more artificial flies and fishing presentation. For example, by confirming the selection, the fly recommendation may be stored in a user log with other fishing condition data such as location, time, etc. In other examples, additionally, or alternatively, the display may include one or more user interface elements where the user add the fly recommendation, e.g., the one or more artificial flies and fishing presentation to a shopping list.

At 509, the method 500 may include determining whether a request to change the match by selecting a new rise reading is received. In response to receiving the request to change the match, the method 500 may include displaying the rise reader interface again at 503. Otherwise, the method may continue to 510. In some examples, changing the input to the rise reader, e.g., selecting subsurface activity instead of surface activity, may generate one or more additional or alternative fly recommendations.

At 510, the method 500 may include determining whether a request to display all recommended flies is received. For example, in addition to the best three flies (or other number), the method 500 may include generating a visual representation of all recommended flies based on the insect identification and the user fly box profile regardless of the fish feeding behavior. Additionally, or alternatively, in addition to the best three flies, the method 500 may include generating a visual representation of all recommended flies based on the insect identification and the fish feeding behavior regardless of the user fly box profile.

At 512, the method 500 may include displaying all recommended flies in the fly recommender interface. For example, as described above, the method 500 may include generating a visual representation of the recommended flies. the user may review the recommended flies, add recommendations to a shopping list, and/or note the recommendations for future fishing trips, for example.

Returning to 504, in response to determining surface activity is not indicated, the method 500 may include determining whether subsurface activity is indicated at 514. In one example, the method 500 may determine subsurface activity is indicated based on the response of the user to selecting the description of subsurface activity as representative of the observed behavior at the fishing location.

In response to determining subsurface activity is indicated, the method 500 may include determining the best flies in the fly box of the user based on subsurface feeding behavior and the identified insect at 516. As above, the method may include determining a recommendation including one or more artificial fly presentations and corresponding artificial flies based on the identified insect, the life cycle stage (or phase), and the subsurface feeding behavior, where the subsurface feeding behavior is assigned a greater weight in determining the recommendation.

At 518, the method 500 may include displaying the recommendation in the fly recommender interface. For example, as described above, the method 500 may include generating a visual representation of the recommended artificial flies including one or more of images, drawings, descriptions, presentation technique, and other associated data, as well as user interface elements to confirm a selection, add a recommendation to a shopping list, as described above. From 518, the method may continue to 510 to determine whether a request to change the match is received, as described above.

Returning again to 504, in response to determining subsurface activity is not indicated, the method 500 may determine no surface activity is indicated at 520. In one example, the method 500 may determine no surface activity is indicated based on the response of the user to selecting the description of no surface activity as representative of the observed behavior at the fishing location.

In response to determining no surface activity is indicated, the method 500 may include determining the best flies in the fly box of the user based on deep feeding behavior and the identified insect at 522. As above, the method may include determining a recommendation including one or more artificial fly presentations and corresponding artificial flies based on the identified insect, the life cycle stage, and the deep feeding behavior, where the deep feeding behavior is assigned a greater weight in determining the recommendation. For example, in response to identifying a stonefly nymph and determination of no surface activity, the method may recommend flies that are found lower in the water column, such as, for example, a nymph rig presentation with two different stonefly imitations.

At 524, the method 500 may include displaying the recommendation in the fly recommender interface. For example, as described above, the method 500 may include generating a visual representation of the recommended artificial flies including one or more of images, drawings, descriptions, presentation technique, other associated data, and user interface elements, as described above. From 524, the method may continue to 510 to determine whether a request to change the match is received, as described above.

The method 500 depicts an approach for automatically generating artificial fly recommendations based on a user fly box, an identified insect, and a fish feeding behavior observation by way of example. In another example, additionally, or alternatively, the method 500 may automatically generate artificial fly recommendations based on fewer, more, or different fishing conditions. For example, additional, or alternative, fishing conditions may include one or more or all of altitude, geography, location, body of water, GPS data, time of year, user settings such as a target fish species, data stored in the user log, data stored in other user's logs, e.g., public data, and others. Further, as noted above, the fishing conditions may be assigned weights to determine the one or more artificial fly recommendations, which may vary depending on the fishing conditions or other factors.

By implementing a multi-model integration approach that integrates determining the rise reading based on the fish behavior parameter with the automated insect identification results from the image processing, the system processes and integrates multiple data streams. The system processes these multiple data streams in parallel to match the identified insect and the rise reading in real time to one or more artificial flies and fishing presentations, allowing the system to handle more information simultaneously and efficiently over sequential or single-stream processing approaches. Further, the approach includes recommendation engines that can operate with or without network connectivity, and user interfaces designed for rapid access to relevant information.

Turning now to FIGS. 6A, 6B, and 6C, a plurality of frames of an exemplary graphical user interface (GUI) 600 is shown. GUI 600 may be displayed by a mobile application to a user via a display of a user computing system as part of one or more methods herein disclosed. Generally, GUI 600 comprises one example of a user interface that may enable users to engage with a fly recommendation system on a mobile application, such as the mobile application 150 in FIGS. 1A-1B. For example, users may view and interact with the fly recommendation system using GUI 600, thereby allowing users to obtain real time recommendations of artificial flies based on real world fishing conditions. In particular, GUI 600 comprises an interface that may enable users to submit a photographic image of an insect, receive an automatic identification of the insect, input a fish feeding behavior observation, and obtain one or more artificial fly recommendations. In one example, the artificial fly recommendations may be determined automatically based on the identified insect, life phase of the identified insect, the fish feeding habit, and the artificial flies in possession of the user. In one example, the fly recommendation system illustrated by GUI 600 may be created according to the methods disclosed herein, such as the method 200, the method 300, the method 400, and the method 500 in FIGS. 2-5, respectively. The example GUI 600 illustrated herein may connect a variety of users, from expert fly fishermen to novices, from technology fans to the technology averse, with an easy to use and effective fly fishing aid.

GUI 600 includes exemplary frames 602, 604, 608, 610, 611, 612, 658, 660, 662, 664, 686, 688, and 690, which are described collectively. In other examples, the GUI 600 may include fewer or more frames, or may comprise different or additional interfaces. For example, GUI 600 may include an introductory series (not shown) that displays user instructions to obtain an artificial fly recommendation based on real time fishing conditions, such as a real time image of an insect, a fish feeding behavior observation, or other conditions. In one example, frame 602 displays a startup screen of the mobile application including a plurality of buttons that link to features of the mobile application in response to a user tapping or otherwise indicating a selection of the button. For example, the frame 602 includes a first button 606 which initiates display of a fly recommender interface, a second button 604 which initiates display of a user log interface, and a third button 605 which initiates display of a map of the user log or hatch log in this example. The frame 602 includes a fourth button 614 which initiates display of manual insect identification features of the application, a fifth button 616 which initiates display of a catch log, a sixth button 618 which initiates display of a database of artificial flies (e.g., the fly index 136 in FIG. 1A), and a seventh button 620 which initiates display of saved flies, e.g., a shopping list.

The frame 602 includes a “fishing tips” button 619, a “home” button 621, and a “settings” button 623. In some examples, the “settings” button 623 may include a setup feature which allows users to select control parameters for fly recommendations. For example, control parameters may include an option to recommend flies based on exact matches or basic matches, which correspond to curated selections (or lists) of artificial flies. Depending on the option input during setup, the fly recommender interface may provide users with fly recommendations from an Exact Match list or a Basic Match list of artificial flies (e.g., one or more artificial fly databases). In one example, the Exact Match flies will provide users with an exact match to the insects identified and the rise reading option selected. The Basic Match flies will provide users with fly recommendations using a smaller list of versatile overlapping and alternate flies that can be used on a variety of insects identified and rise reading option selected. In one example, before heading to the river, users may view the Exact and Basic Match lists via the GUI 600, compare what they have in their possession to the lists, and purchase one or more artificial flies for their tackle box (e.g., see frame 661 in FIG. 6B). In some examples, Exact Match flies and Basic Match flies may be available in preset kits, which may also be purchased via the GUI 600.

Frames 608, 610, 611, 612 show one example of a fly recommender interface. In other examples, the fly recommender interface may include fewer or more frames, or may include different or additional frames, or different or additional interfaces. In one example, subsequent to tapping the first button 606 of the mobile application, the GUI 600 may present the frame 608. The frame 608 displays a camera operating interface, which may enable the user to obtain one or more images of a subject 622 for identification. The frame 608 includes a subject box 624, a scale bar 626 for zooming in or out on the subject 622, a storage button 628 to view and select from images stored in memory of one or both of the mobile phone and the mobile application, a “tips” button 630, and a “capture” button 632. The user may tap the “tips” button 630 to view instructions for capturing high-quality photographic images for insect identification. In other examples, there may be additional control buttons, such as flash control, photo editing tools, and so on. The user may tap the “capture” button 632 to obtain an image for identification.

Subsequent to tapping the “capture” button 632 of the mobile application, the GUI 600 may present the frame 610. In one example, the frame 610 may be presented in response to the mobile application processing the captured image for identification and automatically assigning an identity and life phase to the insect based on an image recognition algorithm, such as described with reference to FIGS. 2 and 4. The frame 610 displays a stored image 634 corresponding to the subject 622 based on the determined identity. The frame 610 also displays a text description 636 of the determined identity and life phase of the subject 622 (e.g., taxonomic classification, formal name, common name, larva, nymph, adult, etc.). The frame 610 further displays one or more images and text description of similar insects 638. The user may confirm the identification by tapping a “continue” button 637.

Subsequent to tapping the “continue” button 637, the GUI 600 may present the frame 611. The frame 611 displays options for reading the rise, including surface feeding activity, subsurface feeding activity, and no surface activity, one of which may be respectively selected by the user via an eighth button 640, a ninth button 642, and a tenth button 644. The buttons 640, 642, 644 may include an exemplary still or animated image of the feeding activity. The user may tap one of the buttons 640, 642, 644 to input a fish feeding behavior observation and view the next frame in the GUI 600.

Subsequent to tapping one of the buttons 640, 642, 644, the GUI 600 may present the frame 612, which is shown over two frames in the example. In one example, the frame 612 may be presented in response to the mobile application generating a fly recommendation based on a fly recommendation algorithm, such as described with reference to FIGS. 2 and 5, including the fish feeding observation input at frame 611, and the identified insect and life phase input at frames 608 and 610. The frame 612 displays the stored image 634 of the subject 622, the corresponding text description 636, and rise reading 641 used in the fly recommendation algorithm. The frame 612 displays the fly recommendation including a presentation 648 including images and written description, and suggested flies 650, 652. In the example shown, the presentation 648 is a double dry hopper and the suggested flies 650, 652 include a lead fly and a dropper fly, respectively. The frame 612 may also include a plurality of buttons 651 which initiate display of additional details, additional, or alternative recommendations.

Turning to FIG. 6B, frame 654 shows an example manual identification interface. In some examples, the manual identification interface may be automatically displayed in response to the image recognition algorithm not recognizing the subject 622. The frame 654 shows the subject box 624 of the subject 622. The frame 654 includes a “manual selection” button 655 and “try again” button 656. For example, the camera operating interface at frame 608 may be displayed in response to users tapping the “try again” button 656 which allows the user to capture a second real time image. The frame 654 further includes a first prompt 657, which may be displayed to guide manual identification of insects. The first prompt 657 includes a “first response” button 658 and a “second response” 659. In the example, the first prompt 657 displays a request to input where the insect was found. The “first response” button 658 inputs “above the water” and the “second response” button 659 inputs “below the water”. In the example, the first prompt 657 is a text prompt. In other examples, prompts may include text, images, or both. In response to inputting one of the two responses by selecting one of the “first response” button 658 and the “second response” 659, additional prompts may be generated. For example, further prompts may include images, text, or both to assist the user to identify features, such as wings, number of legs, etc., habitat, and other taxonomically useful characteristics to identify the subject and its life phase. The manually identified insect may be input to the fly recommendation algorithm, such as shown in Frame 612.

Frames 660 and 661 display examples of a fly box builder interface. In one example, the frame 660 displays an example visual representation of an artificial fly stored in a fly index. The artificial fly may be saved to a shopping list by tapping a “save” button 663. In one example, the frame 661 displays a fly inventory 668 (e.g., a catalog or menu) of artificial flies that are categorized, for example, life cycle, insect imitation, fishing presentation, action, and others. The displayed inventory of artificial flies may include a plurality of selectable buttons 670 which initiate display of more detailed information and options to save flies to a shopping list. In one example, the user may view the fly inventory by tapping a “flies” button 671. The user may view vendor pages to purchase flies saved to the shopping list or other fishing merchandise by tapping a “vendors” button 672. In one example, the user may view curated selections of the fly inventory 668 by selecting the “Exact” button 673 or the “Basic” button 675. Selecting the “Exact” button 673 may initiate display of the Exact Match list and selecting the “Basic” Button 675 may initiate display of the Basic Match list, introduced above with reference to frame 602. In some examples, the user may purchase one or more flies on the Exact Match or Basic Match lists, or purchase a preset kit that includes all of the flies on the Exact Match or Basic Match lists.

In one example, frames 662 and 664 display a visual representation of a user log. As shown in the example, the frame 662 may display a catch log 674 including a record of fish caught 676 by the user, other users (if public), or both. In one example, the fish caught 676 may include one or more or all of an image, species, size, location, date, or relevant categories. Further, the fish caught 676 may be selectable buttons which initiate the display of more detailed information. The frame 662 may display a hatch log 678 including a record of identified insects 680 corresponding to the user, other users (if public), or both. The identified insects 680 may include one or more or all of an image, species, location, date, or relevant categories. Further, the identified insects 680 may be selectable buttons which initiate display of more detailed information. The frame 664 may display a hatch map 682 including a plurality of markers 684 corresponding to fishing experiences, including, for example, identified insects, caught fish, or other relevant data applied to a geographic area. The hatch map 682 may display data corresponding to a single individual's user log, user log(s) of other users (if public), or both. Further, the markers 684 may be selectable buttons which initiate display of more detailed information.

Turning to FIG. 6C, frames 686, 688, and 690 shows further examples of the fly recommender interface. In one example, one or more of the frames 686, 688, and 690 may be presented in response to the mobile application generating a fly recommendation based on a fly recommendation algorithm, such as described with reference to FIGS. 2 and 5, including the fish feeding observation input at frame 611, and the identified insect and life phase input at frames 608 and 610. Further, additionally, or alternatively, one or more of the frames 686, 688, and 690 may be displayed in response to user input indicating selection of one of Exact Match or Basic Match control parameters during setup. The frame 686 displays an example of an Exact Match fly recommendation including an Exact Match fly presentation 691 and Exact Match flies 692, 693 from the Exact Match list (e.g., a first database) of artificial flies. The frame 688 displays an example of a Basic Match fly recommendation including a Basic Match fly presentation 694 and Basic Match flies 695, 696 from the Basic Match list (e.g., a second database) of artificial flies. The frame 690 displays an example of an Alternative Match fly recommendation including an Alternative Match fly presentation 697 and Alternative Match flies 698, 699, which may be recommended from one or both of the Exact Match or Basic Match lists, or another database of artificial flies referenced by the GUI 600. The frames 686, 688, and 690 may also include the plurality of buttons 651 which initiate display of additional details, additional, or alternative recommendations.

In this way, the disclosed systems and methods, and mobile application configured to execute the systems and methods, increase the utility, accuracy, and relevance of fly recommendation over existing approaches. As a few examples, the approach simplifies fly selection in the field by recommending flies based on real time, real world fishing conditions. Among the conditions considered are the flies in possession of the user. The approach also includes features to build a fly box or tackle box that matches the artificial fly database implemented in the recommendation algorithm, thus avoiding irrelevant, and potentially frustrating, recommendations. By providing the user the option to view additional or all recommended flies, and with an option to connect to a retail experience, the user may add alternatives to a shopping list, and/or note the recommendations for future fishing trips. With the support of the mobile application, the user may build a well-equipped fly box and develop expertise in fly selection and presentation. As a result, inexperienced fly fishermen may develop proficiency in the sport more quickly.

The systems and methods described herein provide technical solutions to technical problems arising specifically in the field of fly fishing technology and mobile applications. The disclosed approach implements several specific technical advancements to increase the functioning and accuracy of automated fly recommendation. The system applies computer vision and image recognition algorithms to automatically identify insects and life phases of the insects from captured images. Specifically, the system acquires images through a mobile device camera interface and processes the images by performing noise reduction and feature extraction to detect edges, patterns, and colors. The system matches the processed image features against an insect database and determines insect identity and life phase. The automated identification eliminates manual steps and provides more accurate and rapid identification compared to human visual assessment.

The system implements a multi-model approach that integrates artificial fly data with automated insect identification results from the image processing and fish behavior analysis based on the rise reading. The system processes these multiple data streams in parallel to generate real time, personalized fly recommendations matched to actual fishing conditions. This parallel processing and integration of multiple data streams contributes to enhanced speed, scalability and responsiveness over sequential or single-stream processing approaches.

The system is designed to function in both online and offline modes through local caching of fly box profile data, on-device image processing capabilities, and locally stored matching algorithms. This architecture enables the system to provide recommendations even without network connectivity, which is useful for remote fishing locations. The ordered combination of these technical elements transforms theoretical fly selection principles into a practical application that provides tangible benefits in real-world fishing conditions. The technical architecture enables these features through specific data structures for fly box profiles, insect identification algorithms optimized for mobile devices, recommendation engines that can operate with or without network connectivity, and user interfaces designed for rapid access to relevant information. This represents a technological advancement over existing digital fly fishing aids that rely on manual input or simple database lookups.

The system reduces memory requirements by storing the relevant fly patterns that match the inventory of the user. The automated image recognition capabilities may eliminate manual insect identification steps. The matching algorithms increase recommendation accuracy by considering multiple data points simultaneously through weighted analysis, providing more sophisticated processing than traditional linear matching approaches.

These technical features result in a system that provides more efficient data processing, reduced memory usage, increased accuracy through parallel data stream processing, and maintained functionality in both online and offline environments. The combination of these technical elements creates a practical application that solves real-world problems in the specific field of fly fishing technology.

The disclosure also provides support for a method for a mobile application, comprising: acquiring, with a camera of a mobile device, a first digital visual representation of an insect for identification in real time, comparing the first digital visual representation to a labeled dataset, matching an identity and a life phase to the insect, and storing the identity and the life phase as an identified insect in an insect index, determining a rise reading based on a fish behavior parameter, matching the identified insect and the rise reading in real time to one or more artificial flies and fishing presentations stored in a fly index, and rendering a second digital visual representation of the one or more artificial flies and fishing presentations on a display of the mobile device. In a first example of the method, a greater weight is assigned to the rise reading than the life phase when matching the one or more artificial flies and fishing presentations. In a second example of the method, optionally including the first example, determining the rise reading comprises: displaying a plurality of images of fish feeding behavior on the display of the mobile device, and receiving a user selection of one of the plurality of images. In a third example of the method, optionally including one or both of the first and second examples, the one or more artificial flies and fishing presentations comprises an exact insect imitation, a basic imitation, a best fly presentation, and an alternate fly presentation. In a fourth example of the method, optionally including one or more or each of the first through third examples, the labeled dataset comprises a plurality of images of insects and life cycle phases, and corresponding taxonomic classification, and matching the identity and the life phase to the insect comprises: executing a detection and classification process with reference to one or more machine learning models trained on the labeled dataset, determining a confidence score for the identity and the life phase, and comparing the confidence score to a confidence threshold to determine a reliability of the identification. In a fifth example of the method, optionally including one or more or each of the first through fourth examples, the method further comprises: rendering a third digital visual representation of the identified insect on the display of the mobile device, receiving user affirmation of the identified insect, and storing the first digital visual representation of the identified insect, the identity, and the life phase in the labeled dataset. In a sixth example of the method, optionally including one or more or each of the first through fifth examples, the method further comprises: processing the first digital visual representation of the insect to generate a processed image for identification, adjusting image data by performing noise reduction and feature extraction, detecting edges, patterns, and colors, matching the processed image to the labeled dataset, and generating a confidence score for the identified insect. In a seventh example of the method, optionally including one or more or each of the first through sixth examples, the method further comprises: generating and displaying a user interface to build and store a user fly box profile representing artificial flies in possession of a user, and matching the identified insect and the rise reading to one or more artificial flies in the user fly box profile. In a eighth example of the method, optionally including one or more or each of the first through seventh examples, the user fly box profile comprises one of a plurality of preset fly box profiles and corresponding kits, including minimalist, medium, and well-equipped collections of artificial flies. In a ninth example of the method, optionally including one or more or each of the first through eighth examples, the method further comprises: receiving a user request to save one or more artificial flies to a shopping list, and storing the shopping list in a retailer index.

The disclosure also provides support for a system comprising: a mobile device comprising a display and camera, a mobile application in electronic communication with the mobile device, and a processor with computer readable instructions stored on non-transitory memory that when executed during electronic communication with the mobile application and the mobile device cause the processor to: generate and display one or more user interfaces by the mobile application to receive inputs to a fly recommendation algorithm, receive a real time digital visual representation of an insect, captured via the camera, automatically match the real time digital visual representation to an identity and a life phase of the insect in a labeled dataset using image recognition, and store the identity and the life phase as an identified insect in a first memory location, receive a first fishing condition at a location where a user is requesting a fly recommendation, input via the display, and store the first fishing condition in a second memory location, receive a plurality of artificial flies from a third memory location, determine the fly recommendation from the plurality of artificial flies based on the identified insect and the first fishing condition, and render a digital visual representation of the fly recommendation on the display of the mobile device. In a first example of the system, the processor with computer readable instructions stored on non-transitory memory that when executed during electronic communication with the mobile application and the mobile device cause the processor to further comprise: automatically assign a first weight to the identified insect and a second weight to the first fishing condition, and determine the fly recommendation based on the first weight, the identified insect, the second weight, and the first fishing condition. In a second example of the system, optionally including the first example, the fly recommendation comprises one or more fishing presentations and one or more artificial flies, the first fishing condition comprises a rise reading, and the computer readable instructions stored on non-transitory memory further comprise: determine a fishing presentation based on the rise reading and the life phase of the insect, where a greater weight is assigned to the rise reading than the life phase of the insect when determining the fishing presentation, and select the one or more artificial flies based on the determined fishing presentation and the identity of the insect. In a third example of the system, optionally including one or both of the first and second examples, the processor with computer readable instructions stored on non-transitory memory that when executed during electronic communication with the mobile application and the mobile device cause the processor to further comprise: display one or both of a plurality of images and descriptions of fish feeding behavior via the one or more user interfaces, display a prompt requesting a user selection of the fish feeding behavior most similar to behavior observed by the user at a fishing location, receive the user selection, and store the user selection in the second memory location. In a fourth example of the system, optionally including one or more or each of the first through third examples, the processor with computer readable instructions stored on non-transitory memory that when executed during electronic communication with the mobile application and the mobile device cause the processor to further comprise: load the plurality of artificial flies from the third memory location and display the plurality of artificial flies for user selection, and in response to the user selection of one or more artificial flies of the plurality of artificial flies: store the one or more artificial flies as a user fly box profile representing artificial flies in possession of the user, and determine the fly recommendation from the plurality of artificial flies based on the identified insect, the first fishing condition, and the user fly box profile. In a fifth example of the system, optionally including one or more or each of the first through fourth examples, the processor with computer readable instructions stored on non-transitory memory that when executed during electronic communication with the mobile application and the mobile device cause the processor to further comprise: execute a detection and classification process with reference to one or more machine learning models trained on the labeled dataset, determine a confidence score for the identity and the life phase, compare the confidence score to a confidence threshold to determine a reliability of the identified insect, add the identified insect to the labeled dataset in response to the confidence score exceeding the confidence threshold, and display a request to acquire a second real time digital visual representation or identify the insect manually in response to the confidence score not exceeding the confidence threshold. In a sixth example of the system, optionally including one or more or each of the first through fifth examples, the mobile application comprises: a first online mode utilizing networked computing systems for processing tasks when network connectivity is available, and a second offline mode utilizing local data storage and processing capabilities when network connectivity is unavailable, wherein the second offline mode maintains image recognition and fly recommendation functionalities through cached insect identification models and fly matching algorithms stored locally.

The disclosure also provides support for a non-transitory memory with instructions stored thereon, that when executed by a processor, cause the processor to perform operations comprising: generating and displaying one or more user interfaces by a mobile application to receive inputs to a fly recommendation algorithm, acquiring a first digital visual representation of an insect for identification in real time, the first digital visual representation captured via the one or more user interfaces of the mobile application, comparing the first digital visual representation to a labeled dataset in real time, matching an identity and a life phase to the insect, and storing the identity and the life phase as an identified insect in a first memory location, determining rise reading based on a fish behavior parameter and storing the rise reading in a second memory location, matching the identified insect and the rise reading in real time to one or more artificial flies and fishing presentations stored in a third memory location, and displaying a second digital visual representation of the one or more artificial flies and fishing presentations on the one or more user interfaces. In a first example of the non-transitory memory with instructions stored thereon, that when executed by the processor, cause the processor to perform operations of claim 18, further comprising: receiving a user request to save one or more recommended flies to a shopping list and storing the shopping list in a fourth memory location, receiving, via the one or more user interfaces, a fly shop request, and displaying a digital visual representation of the shopping list on a fly shop interface. In a second example of the non-transitory memory with instructions stored thereon, that when executed by the processor, cause the processor to perform operations of claim 18, optionally including the first example, further comprising: storing one or more of a recommended fly, a recommended fishing presentation, the first digital visual representation of the insect captured via the one or more user interfaces, date, time, location, species of fish caught, and other notes as a user log in a fifth memory location, receiving, via the one or more user interfaces, a user request to view the user log, generating a digital visual representation of the user log, and displaying the digital visual representation on the one or more user interfaces.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a mobile application, comprising:
acquiring, with a camera of a mobile device, a first digital visual representation of an insect for identification in real time;
comparing the first digital visual representation to a labeled dataset, matching an identity and a life phase to the insect, and storing the identity and the life phase as an identified insect in an insect index;
determining a rise reading based on a fish behavior parameter;
matching the identified insect and the rise reading in real time to one or more artificial flies and fishing presentations stored in a fly index; and
rendering a second digital visual representation of the one or more artificial flies and fishing presentations on a display of the mobile device.

2. The method for the mobile application of claim 1, wherein a greater weight is assigned to the rise reading than the life phase when matching the one or more artificial flies and fishing presentations.

3. The method for the mobile application of claim 1, wherein determining the rise reading comprises:
displaying a plurality of images of fish feeding behavior on the display of the mobile device; and
receiving a user selection of one of the plurality of images.

4. The method for the mobile application of claim 1, wherein the one or more artificial flies and fishing presentations comprises an exact insect imitation, a basic imitation, a best fly presentation, and an alternate fly presentation.

5. The method for the mobile application of claim 1, wherein the labeled dataset comprises a plurality of images of insects and life cycle phases, and corresponding taxonomic classification, and matching the identity and the life phase to the insect comprises:
executing a detection and classification process with reference to one or more machine learning models trained on the labeled dataset;
determining a confidence score for the identity and the life phase; and
comparing the confidence score to a confidence threshold to determine a reliability of the identification.

6. The method for the mobile application of claim 5, further comprising:
rendering a third digital visual representation of the identified insect on the display of the mobile device;
receiving user affirmation of the identified insect; and
storing the first digital visual representation of the identified insect, the identity, and the life phase in the labeled dataset.

7. The method for the mobile application of claim 1, further comprising:
processing the first digital visual representation of the insect to generate a processed image for identification;
adjusting image data by performing noise reduction and feature extraction;
detecting edges, patterns, and colors;
matching the processed image to the labeled dataset; and
generating a confidence score for the identified insect.

8. The method for the mobile application of claim 1, further comprising generating and displaying a user interface to build and store a user fly box profile representing artificial flies in possession of a user, and matching the identified insect and the rise reading to one or more artificial flies in the user fly box profile.

9. The method for the mobile application of claim 8, wherein the user fly box profile comprises one of a plurality of preset fly box profiles and corresponding kits, including minimalist, medium, and well-equipped collections of artificial flies.

10. The method for the mobile application of claim 1, further comprising:
receiving a user request to save one or more artificial flies to a shopping list; and
storing the shopping list in a retailer index.

11. A system comprising:
a mobile device comprising a display and camera;
a mobile application in electronic communication with the mobile device; and
a processor with computer readable instructions stored on non-transitory memory that when executed during electronic communication with the mobile application and the mobile device cause the processor to:
generate and display one or more user interfaces by the mobile application to receive inputs to a fly recommendation algorithm;
receive a real time digital visual representation of an insect, captured via the camera, automatically match the real time digital visual representation to an identity and a life phase of the insect in a labeled dataset using image recognition, and store the identity and the life phase as an identified insect in a first memory location;
receive a first fishing condition at a location where a user is requesting a fly recommendation, input via the display, and store the first fishing condition in a second memory location;
receive a plurality of artificial flies from a third memory location;
determine the fly recommendation from the plurality of artificial flies based on the identified insect and the first fishing condition; and
render a digital visual representation of the fly recommendation on the display of the mobile device.

12. The system of claim 11, wherein the processor with computer readable instructions stored on non-transitory memory that when executed during electronic communication with the mobile application and the mobile device cause the processor to further comprise:
automatically assign a first weight to the identified insect and a second weight to the first fishing condition; and
determine the fly recommendation based on the first weight, the identified insect, the second weight, and the first fishing condition.

13. The system of claim 11, wherein the fly recommendation comprises one or more fishing presentations and one or more artificial flies, the first fishing condition comprises a rise reading, and the computer readable instructions stored on non-transitory memory further comprise:
determine a fishing presentation based on the rise reading and the life phase of the insect, where a greater weight is assigned to the rise reading than the life phase of the insect when determining the fishing presentation; and
select the one or more artificial flies based on the determined fishing presentation and the identity of the insect.

14. The system of claim 11, wherein the processor with computer readable instructions stored on non-transitory memory that when executed during electronic communication with the mobile application and the mobile device cause the processor to further comprise:
display one or both of a plurality of images and descriptions of fish feeding behavior via the one or more user interfaces;
display a prompt requesting a user selection of the fish feeding behavior most similar to behavior observed by the user at a fishing location;
receive the user selection; and
store the user selection in the second memory location.

15. The system of claim 11, wherein the processor with computer readable instructions stored on non-transitory memory that when executed during electronic communication with the mobile application and the mobile device cause the processor to further comprise:
load the plurality of artificial flies from the third memory location and display the plurality of artificial flies for user selection; and
in response to the user selection of one or more artificial flies of the plurality of artificial flies:
store the one or more artificial flies as a user fly box profile representing artificial flies in possession of the user; and
determine the fly recommendation from the plurality of artificial flies based on the identified insect, the first fishing condition, and the user fly box profile.

16. The system of claim 11, wherein the processor with computer readable instructions stored on non-transitory memory that when executed during electronic communication with the mobile application and the mobile device cause the processor to further comprise:
execute a detection and classification process with reference to one or more machine learning models trained on the labeled dataset;
determine a confidence score for the identity and the life phase;
compare the confidence score to a confidence threshold to determine a reliability of the identified insect;
add the identified insect to the labeled dataset in response to the confidence score exceeding the confidence threshold; and
display a request to acquire a second real time digital visual representation or identify the insect manually in response to the confidence score not exceeding the confidence threshold.

17. The system of claim 11, wherein the mobile application comprises:
a first online mode utilizing networked computing systems for processing tasks when network connectivity is available; and
a second offline mode utilizing local data storage and processing capabilities when network connectivity is unavailable, wherein the second offline mode maintains image recognition and fly recommendation functionalities through cached insect identification models and fly matching algorithms stored locally.

18. A non-transitory memory with instructions stored thereon, that when executed by a processor, cause the processor to perform operations comprising:
generating and displaying one or more user interfaces by a mobile application to receive inputs to a fly recommendation algorithm;
acquiring a first digital visual representation of an insect for identification in real time, the first digital visual representation captured via the one or more user interfaces of the mobile application;
comparing the first digital visual representation to a labeled dataset in real time, matching an identity and a life phase to the insect, and storing the identity and the life phase as an identified insect in a first memory location;
determining rise reading based on a fish behavior parameter and storing the rise reading in a second memory location;
matching the identified insect and the rise reading in real time to one or more artificial flies and fishing presentations stored in a third memory location; and
displaying a second digital visual representation of the one or more artificial flies and fishing presentations on the one or more user interfaces.

19. The non-transitory memory with instructions stored thereon, that when executed by the processor, cause the processor to perform operations of claim 18, further comprising:
receiving a user request to save one or more recommended flies to a shopping list and storing the shopping list in a fourth memory location;
receiving, via the one or more user interfaces, a fly shop request; and
displaying a digital visual representation of the shopping list on a fly shop interface.

20. The non-transitory memory with instructions stored thereon, that when executed by the processor, cause the processor to perform operations of claim 18, further comprising:
storing one or more of a recommended fly, a recommended fishing presentation, the first digital visual representation of the insect captured via the one or more user interfaces, date, time, location, species of fish caught, and other notes as a user log in a fifth memory location;
receiving, via the one or more user interfaces, a user request to view the user log;
generating a digital visual representation of the user log; and
displaying the digital visual representation on the one or more user interfaces.
